(19) United States
(12) Patent Application Publication
(10) Pub. No.: US 2020/0038745 A1
(43) Pub. Date: Feb. 6, 2020

(54) GEAR (GAME ENHANCING AUGMENTED REALITY): A LOWER LIMB ALTERNATIVE CONTROL INTERFACE FOR COMPUTERS

(71) Applicant: THE JOHNS HOPKINS UNIVERSITY, Baltimore, MD (US)

(72) Inventors: Gyorgy LEVAY, Baltimore, MD (US); Adam LI, Thousand Oaks, CA (US); Nhat Nate TRAN, Dong Nai (VN)

(73) Assignee: The Johns Hopkins University, Baltimore, MD (US)

(21) Appl. No.: 16/309,183

(22) PCT Filed: Jun. 19, 2017
(86) PCT No.: PCT/US2017/038089

§ 371 Date: Dec. 12, 2018

Related U.S. Application Data
(60) Provisional application No. 62/351,397, filed on Jun. 17, 2016.

(51) Int. Cl. A63F 13/212; A63F 13/218

(52) U.S. Cl. CPC A63F 13/212; A63F 13/24; A63F 13/218

(57) ABSTRACT

An embodiment in accordance with the present invention provides a device that transfers dexterous control of computers from hands to feet. The device of the present invention is a wearable foot based control interface for computers with a user interface that allows for a high level of customization. The device of the present invention provides an option to effectively control computers using ones feet. An innovative sensor design according to the present invention provides high sensitivity and robust usability. A graphic user interface according to the present invention allows for significant user customization of output commands and input sensitivity. The device of the present invention is wearable and provides comfort and intuitive usability.

### CROSS REFERENCE TO RELATED APPLICATIONS

This application claims the benefit of U.S. Provisional Patent Application No. 62/351,397 filed on Jun. 17, 2016, which is incorporated by reference, herein, in its entirety.

### FIELD OF THE INVENTION

The present invention relates generally to interface control devices. More particularly, the present invention relates to a lower limb alternative control interface for computers.

### BACKGROUND OF THE INVENTION

Most dexterous control devices, such as gaming controllers, joysticks, etc. are for dexterous control by a hand or hands of a user. However, in some instances, users don't have hand dexterity in order to control these hand operated devices. In other instances, users have amputations, conditions, or injuries that reduce or eliminate the ability to hand control a device.

Therefore, it would be advantageous to provide a lower limb alternative control interface for computers.

### SUMMARY OF THE INVENTION

The foregoing needs are met, to a great extent, by the present invention, wherein in one aspect a system for computer control includes a housing shaped to accommodate a foot of a user. The system includes a pad disposed on a surface of the housing. The system also includes a force sensor embedded in the pad. The force sensor is configured to be actuated by a foot of a user. A non-transitory computer readable medium is programmed for translating output from the force sensor into control commands for a computing device.

In accordance with an aspect of the present invention, the system includes a housing for a left foot of the user and a housing for a right foot of the user, such that the user can control the computer with both feet. The housing for the left foot of the user and the housing for the right foot of the user are individually controllable. The pad includes a front portion and a back portion. The housing can also include a front portion and a back portion. The front portion and the back portion are coupled by rails. The rails allow for adjustability of the size of the housing. The pad is formed from silicone. The system includes a microcontroller and a microprocessor. The system includes a graphical user interface (GUI). The system can include three sensors. One of the three sensors is embedded in a front portion of the pad and two of the three sensors are embedded in a back portion of the pad. The force sensor is embedded adjacent to a ground contact point. The non-transitory computer readable medium is programmed for the input from the force sensor to be translated to approximate keyboard strokes. The force sensor is configured for gradual change in resistance value when force is applied to the force sensor. The sensor is configured for generating commands. The system can include multiple force sensors. The multiple force sensors are engaged in different configurations to generate different commands. The GUI is configured for user input of settings for the force sensors. The GUI is configured for the user to input commands associated with different combinations of engaging the multiple force sensors. The multiple force sensors are configured to generate different commands based on the pressure applied to the multiple force sensors.

### BRIEF DESCRIPTION OF THE DRAWINGS

The accompanying drawings provide visual representations, which will be used to more fully describe the representative embodiments disclosed herein and can be used by those skilled in the art to better understand them and their inherent advantages. In these drawings, like reference numerals identify corresponding elements and:

FIG. 1 illustrates a perspective view of embedded sensors, according to an embodiment of the present invention.

FIGS. 2A-2C illustrate image views of the embedded, combined circuit boards, according to an embodiment of the present invention.

FIG. 3 illustrates a flow diagram of implementation of software, according to an embodiment of the present invention.

FIG. 4 illustrates an image view of a graphical user interface, according to an embodiment of the present invention.

FIG. 5 illustrates a flow diagram of keyboard control software, according to an embodiment of the present invention,

FIGS. 6A-6C illustrate image views of various embodiments of a system of the present invention.

FIGS. 7A-7C illustrate perspective views of components of a system of the present invention.

FIGS. 8A and 8B illustrate perspective views of components of a system of the present invention.

FIGS. 9A-9C illustrate perspective views of molds used to create the embedded sensors.

FIG. 10 illustrates a schematic diagram of circuitry for sensory communication and button/LED functionality.

FIG. 11 illustrates a flow diagram of an assembly process for a system according to the present invention.

### DETAILED DESCRIPTION

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

An embodiment in accordance with the present invention provides a device that transfers dexterous control of computers from hands to feet. The device of the present invention is a wearable foot based control interface for computers with a user interface that allows for a high level of customization. The device of the present invention provides an option to effectively control computers using ones feet. An innovative sensor design according to the present invention provides high sensitivity and robust usability. A graphic user interface according to the present invention allows for significant user customization of output commands and input sensitivity. The device of the present invention is wearable and provides comfort and intuitive usability.

The key hardware components include a frame, embedded sensors, and internal circuitry. The key software components include an embedded system control, a customized graphical user interface (GUI), and keyboard control. These components and their interaction to form a system for the present invention are described further, below.

A frame that conforms the device to the anatomy of the foot and keeps it attached in a stable fashion, while also internally housing the required circuitry and creating connection between the two feet and the computer to which it serves as an interface. The frame also provides a possibility for universal design. Creating a frame that can be adjusted based on individual user parameters is a primary objective of the present invention. The main focuses when designing the frame are as follows:
Stability: Designing a durable, robust frame to ensure both the safety of the user and protection of sensors and circuitry housed within.
Comfort: The frame must provide a high level of comfort to enable seamless and continuous usability.
Universal design: The device must adjustable to fit a wide range of potential users. Primary direction of adjustability should be in its length to account for varying foot sizes.

A preferred embodiment of the present invention includes force sensors embedded into silicone pads. Embedding the force sensors into silicone pads enables the device to be both highly sensitive and at the same time resilient against accidental activation. The force sensors are positioned at the tip of the pads near the ground-contact points, which result in an accumulation of applied force around the area of the sensors. The force sensors are configured to create a gradual change in their resistance value when force is applied. The fluctuation in the resistance value can be detected and functions can be assigned based on the levels recorded. These properties make the design of the present invention ideal for the challenge presented by computer control using the feet, creating a possibility to leverage high sensitivity and robustness while creating a customizable and versatile control mechanism.

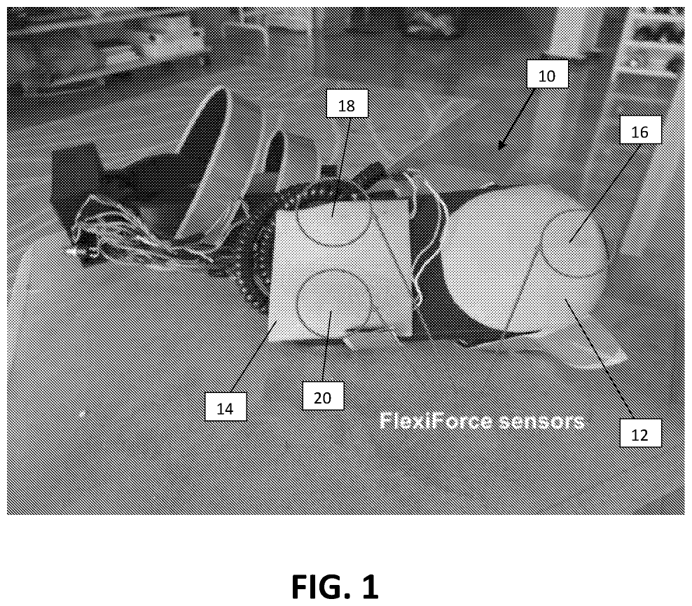

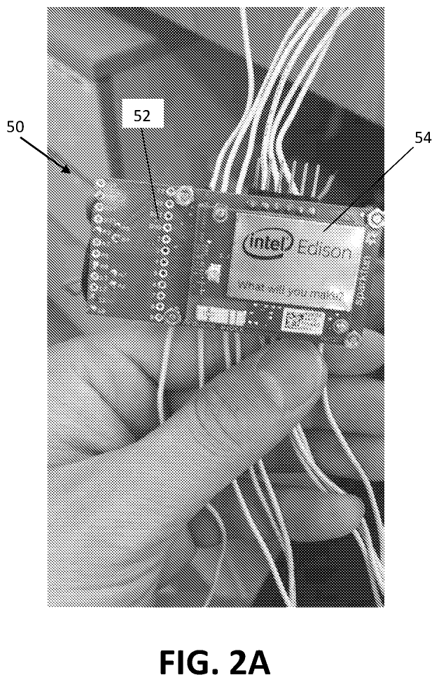

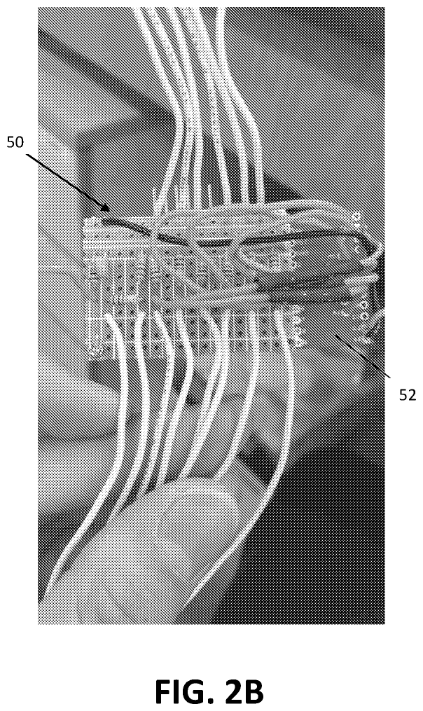

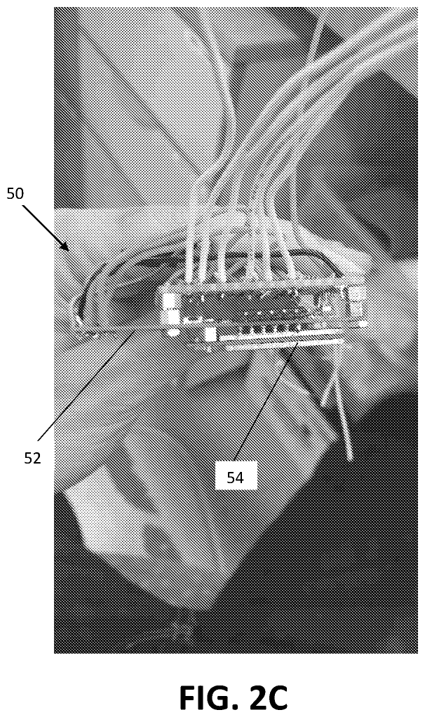

All wires connecting the sensors and the circuit board must run internally, hidden from environmental hazards. Wiring needs to account for adjustability by leaving excess wires where they are required. Connection between the two foot modules is achieved through a coiled cable, which allows easy individual and independent movement of each foot, while at the same time protecting sensitive wiring. The wires connect to the circuit board of which the central element is a microcontroller, as illustrated in FIGS. 2A-2C. Any suitable microcontroller or other device known to or conceivable to one of skill in the art can also be used. The microcontroller is connected to a computer via a USB connection or other suitable connection known to or conceivable to one of skill in the art, through which it feeds preprocessed sensory information in the form of keyboard and mouse commands. Communication is achieved through a serial port. FIG. 1 illustrates a perspective view of embedded sensors, according to an embodiment of the present invention. This concept enables the device to be both highly sensitive and at the same time resilient against accidental activation.

As illustrated in FIG. 1, a foot control module 10 can include silicone pads 12 and 14. Force sensors 16, 18, and 20 are embedded in the silicone pads 12 and 14. As noted above, preferably, force sensors 16, 18, and 20 are located at the edges of the pads near the ground contact points and in positions easily accessible by the user's toes or heel. Any number of sensors can be included as would be known to or conceivable by one of skill in the art. Three sensors are included herein, simply by way of example. The pads 12 and 14 are configured to be disposed on a surface of a frame or housing configured to receive a sole of the foot of the user.

Determining ideal sensor number and positions for maximum usability is one of the most important criteria of the present invention. Determination is based on factors such as possibility of simultaneous sensor activation, ease of force application (performing a movement should come naturally), limited complexity to maintain intuitive use and stability when wearing the device.

GEAR is powered by a microprocessor, connected with a microcontroller to provide input/output (I/O) capabilities. All software components are stored on a cloud repository, server or other storage location, known to or conceivable to one of skill in the art. The software is split into three components detailed below.

Embedded System Control:

This aspect of the hardware deals with the I/O communication between the microprocessor and the sensors and button in a system of the present invention. This part of the code is programmed to provide functionality to read sensor analog values, read button press, write digital values to LED pin, and also send Serial commands over the Serial port of the RX/TX pins on the microprocessor. The Serial commands that are sent over the Serial port are used by the Keyboard Control section to carry out the various keyboard commands that are set for that specific sensor action. Each sensor is connected to a pin on the pinout of the microcontroller block that is then connected and read by the microprocessor. The software here also does various digital checks to determine the actions intended by user. For example, if the user presses on his/her right toes forward, then it might move the user forward in the game. They could also have set the command to be ‘w’, which is a common command for moving forward in a video game. This can be easily customized in the GUI customization part of the code. The software architecture does various checks for thresholds that are set by the user, to carry out these various commands. FIGS. 2A-2C illustrate perspective views of a module 50 including an embedded, combined circuit board 52 and microprocessor 54. All electronic components connect to this module 50, which processes the sensory information, produces commands based on the processed data and communicates with the computer through a connector such as a serial port. The microprocessor communicates with the microcontroller via a selectable UART, so the microprocessor can interact over a serial interface. The reduced size helps compress the space needed for the circuit board and allows placement of the entire circuitry in a separated compartment that is protected and is not exposed to the environment.

GUI Customization:

The graphical user interface (GUI) creates an interface for users to customize commands for the various sensors. For example, the user can set the front right toe sensors to be ‘w’, or ‘e’, or ‘q’ and the software will automatically register what the user sets. Then, whenever the user presses that corresponding sensor, the embedded system will read in the values for that sensor and threshold to send serial commands over the serial port. This is very important for giving the user a seamless experience and freedom to customize their commands and sensitivity to the sensors with the system of the present invention. The GUI provides various scroll down menus for each sensor configuration. The user can easily pick and choose which of the various common commands for “front”, “backwards”, “right”, “left”, etc. are. Then they press a “set commands” button and the GUI system uses Serial commands to set class variables within the embedded system controls. Then whenever the user activates a certain sensor configuration, then the system will send a Serial command that corresponds to the customized command the user set through the GUI.

Keyboard Control:

The last component of software that was required was a program running on the user's computer that would be able to receive Serial commands and then simulate Keyboard strokes on the computer. The Serial information is the backbone of all three software components. From the embedded system control, Serial commands are sent via USB port with the serial bus on the microcontroller. This program handles two main functions: i) a serial port class for handling basic reading/writing of data over the Serial port. Then it will grab the corresponding data that was sent over Serial port. ii) a Keyboard emulator that has various conditional statements for checking data input and then taking over the low level functionality of Keyboard strokes.

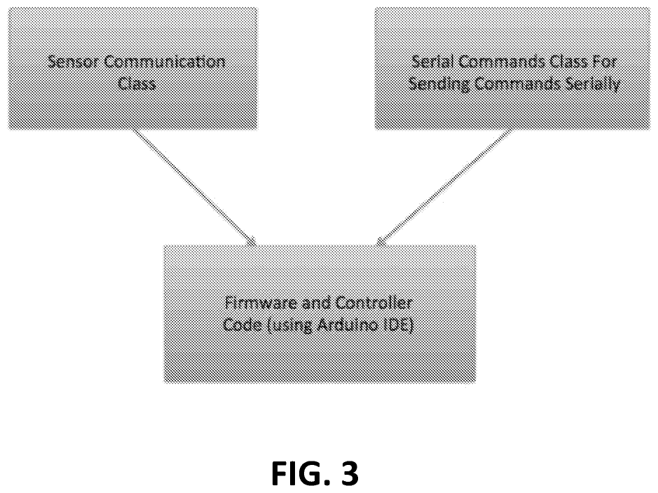

As illustrated in FIG. 3, the block diagram shows how the software is implemented on the microprocessor. Functionality was split into handling basic I/O reading and writing of the sensor, button and LED pins, and also a class for determining what Keyboard strokes to press for the different commands a user wants to implement. Finally, they are used by the main controller to flash the firmware.

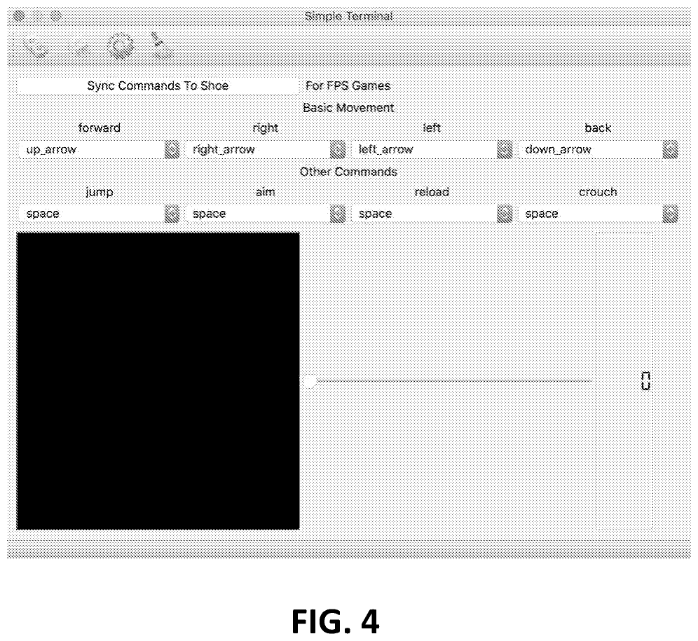

FIG. 4 illustrates a graphical user interface that can set various commands for all common commands used in a game. The eight common commands that are set right now are forward, right, left, back, jumping, aiming, reloading and crouching. Each command has a dropdown menu that users can select from and then there is a slider for setting sensitivity values for each command. The user can sync commands to GEAR over the Serial port by pressing the button “Sync Commands To Shoe”.

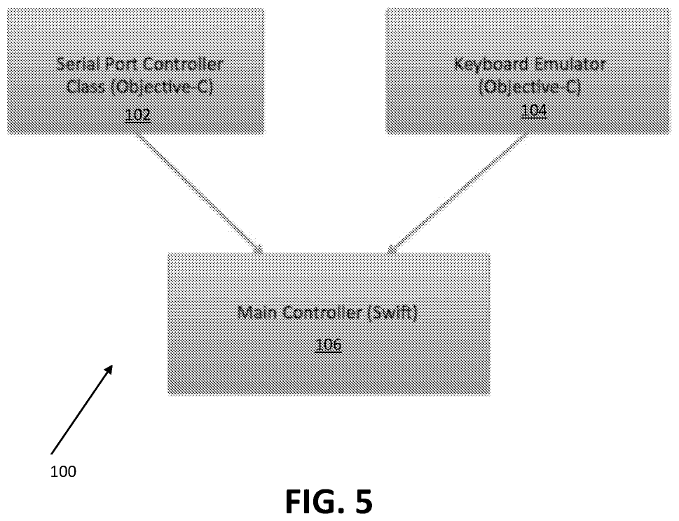

FIG. 5 illustrates a block diagram showing the implementation and handling of the Keyboard control software. This is essentially a command-line program that is launched and connects with the Serial port being used by the system of the present invention. Then the system of the present invention can receive commands from the embedded systems control, so that the system of the present invention can carry out the Keyboard strokes. This part of the entire software is important for carrying out the intended functionality of the system of the present invention. It is designed to be simple and fast, so that users are not worried about the backend operations. The method of keyboard control 100 is achieved by receiving input from the serial port controller 102 and the keyboard emulator 104 at the main controller 106.

The following section serves as a step by step description of the device to provide repeatable assembly. The section contains two main subsections, one regarding hardware documentation and the other providing a detailed discussion on the software aspects of the project. Insight is provided in the documentation on why a specific design or method was chosen in an effort to transfer institutional knowledge to the reader.

Hardware Documentation:

The hardware design and assembly for the final prototype consisted of three main blocks that will be discussed in three subsections. These are frame, embedded sensors and circuitry. A fourth subsection will discuss assembly.

Frame:

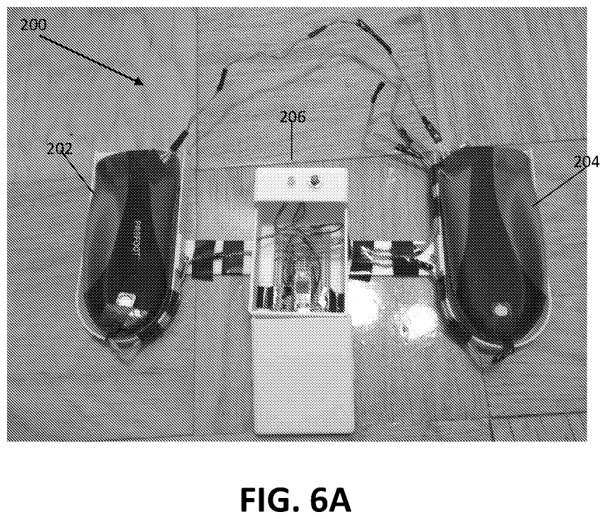

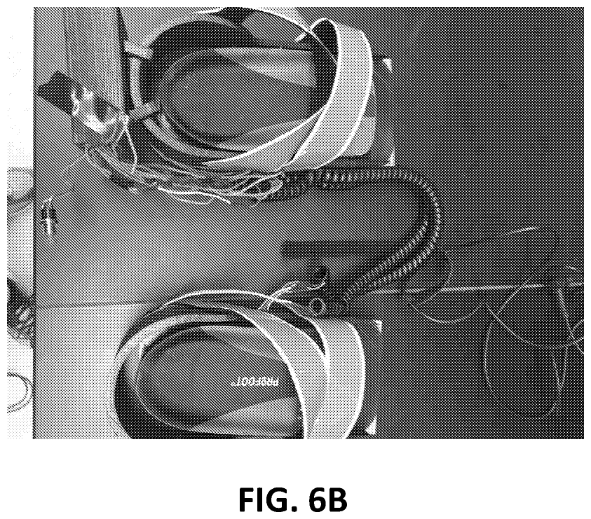

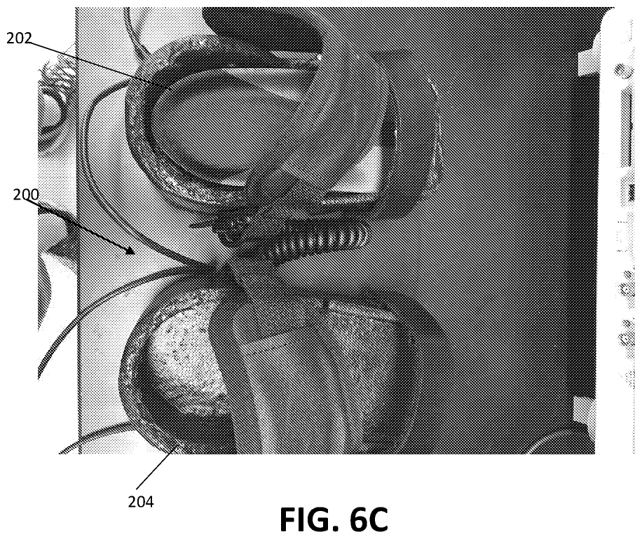

The frame of the device went through three main iterations before the third (and final) framework was designed. After creating a design that attaches to the feet rather than remaining in constant contact with the ground (two embodiments of the present invention), the primary goal became to develop a frame that internally houses all electric and sensory components, provides adaptability to the user's foot size, and does not require other modules than the two platforms attached to the feet. FIGS. 6A-6C illustrate perspective views of the various embodiments of the present invention. The system 200 includes foot modules 202 and 204. The foot modules include silicone pads with embedded force sensors, as illustrated in FIG. 1. The embodiment of the system 200 shown in FIG. 6A includes a separate control module 206. FIGS. 6B and 6C illustrate the control module being incorporated into one of the foot modules.

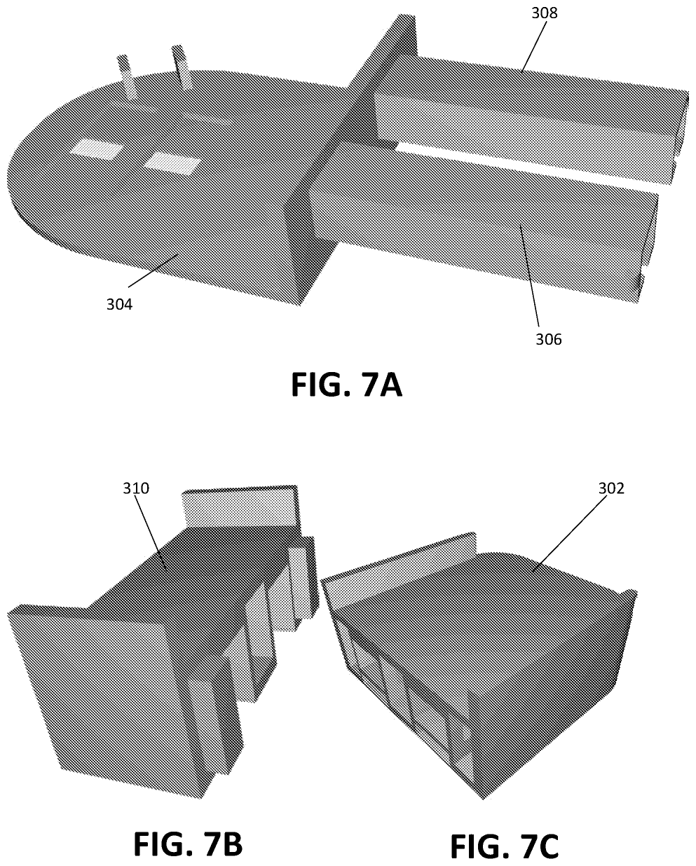

FIGS. 7A-7C illustrate perspective views of the components of a frame for the system according to the present invention. To incorporate size adaptability, the frame was divided into two separate sections, front 302 and back 304, as illustrated in FIGS. 7A-7C. Beams 306 and 308 attached to the back section connect the back to the front and run inside the front, creating a rail through which the length of device can be extended. To lock the device into a desired position, ratchet clamps on the side of the platform connect to both front and back sections and can be used to lock the components in place. Additional middle sections 310 can be placed between the two segments to create a more stable frame.

Next, internal space had to be created to account for circuitry and wiring. Sensors were to be placed on both front and back portion, which meant a change in length of the wires needed to be accounted for. The rails were hollowed out and small holes were designed in both the front and back section to allow for the entry of the wires connected to the embedded sensors. The top element of the back section was designed to hold the heel in place and to be detachable from the bottom section to make assembly and troubleshooting easier.

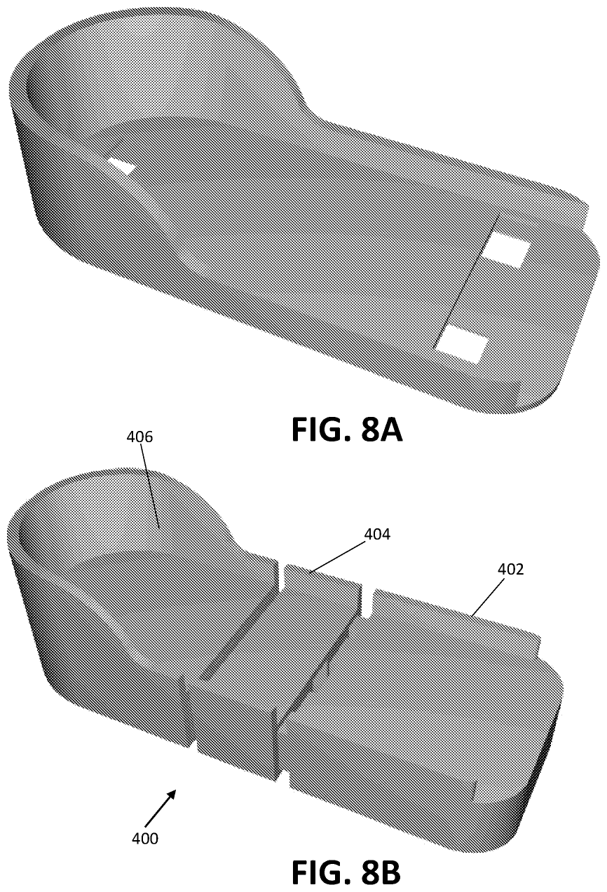

FIGS. 8A and 8B illustrate another embodiment alongside the CAD image of the embodiment described above. The embodiment of FIGS. 8A and 8B gained 5 cm in height, but this allowed all circuitry and wiring to be concealed and safe from environmental hazards. To connect the two platforms (left and right foot) a coiled HDMI wire was used. HDMI was chosen over telephone cables due to the need for transferring 6 leads (two for each sensor) and a telephone cables only provide 4. The purpose of the coiling is to allow for free movement of the feet relative to each other, while eliminating the hazard of excess wires. The length of the cable when coiled is approximately 1 foot, which is the average distance between the feet of a grown person when sitting down. The difference in design for the left and right platform is in two opening on the outer side of the left foot, the opening are the outlets for the LED/Pushbutton and USB connection cable. Other than these, the two platforms are mirror images of each other. Openings were designed on the bottom of the platforms (Both front and back components) to allow for the attachment of the embedded sensors. The details of these connectors will be discussed in the next section.

FIGS. 7A-7C illustrate perspective views of a bottom of back component, middle component for extension and front component. The beams on the back component allow for customizable length, while also shielding the wires running from the frontside sensors.

FIG. 8A shows the CAD model of another embodiment. FIG. 8B shows the model of the embodiment of FIG. 8A with all its components assembled. The holes visible on the second prototype also exist on the third, their purpose is stable attachment of the embedded sensors. Faux Leather was applied to frame with a two component epoxy adhesive to help protect against environmental hazards. Other materials or surface protectant known to or conceivable to one of skill in the art could also be used. Straps were fastened to the frame to achieve stable attachment of the device to the feet. The straps were held to the frame with sinking screws (with the aim of eliminating any extruding object near the foot) and ratchet clamps for easy adjustability. Edges were coated with black silicone glue to create dull, rubbery surfaces that do not cause discomfort to the wearer. FIG. 8B illustrates the frame 400. The frame 400 includes front 402, middle 404, and back 406 components.

Embedded Sensors:

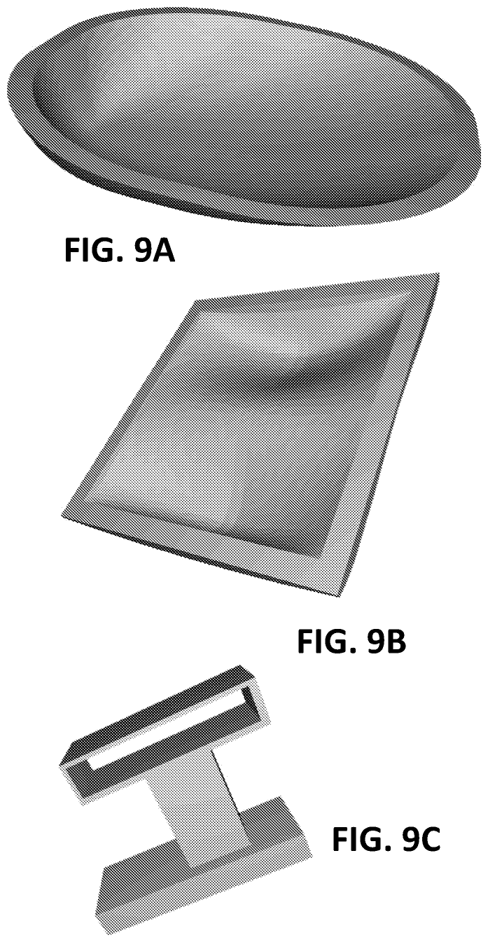

The embedded sensors were created as a modification. The aim was to create a wider range of sensitivity while providing additional robustness to the device. By embedding the sensors near the small ground-contact surfaces created by the shapes of the pads, any applied force in a particular direction would accumulate over the force sensor, eliminating the need for the feet to maintain precise positioning. Molds were created using 3D printing, as illustrated in FIGS. 9A-9C, and a dual component silicone with a shore hardness value of 15 was used to produce the required shapes. The sensors were positioned in the molds with special consideration given to connective wire positions, before the silicone was poured into the mold.

After combining the two components, the molds were filled with the silicone and before the material set, 3D printed attachment modules were put into the fluid. The purpose of these modules was to create a mechanical connector between the silicone pads and the platforms, as initial attempts proved to be unsuccessful through the use of a multitude of adhesives. These small connectors are only half immersed in the silicone with their exposed halves connected to the platforms via thin cross beams. The silicone is then allowed to set and is finally coated with faux leather or other suitable mater or protective coating known to or conceivable to one of skill in the art to protect from strain caused by use and other environmental hazards.

Circuitry:

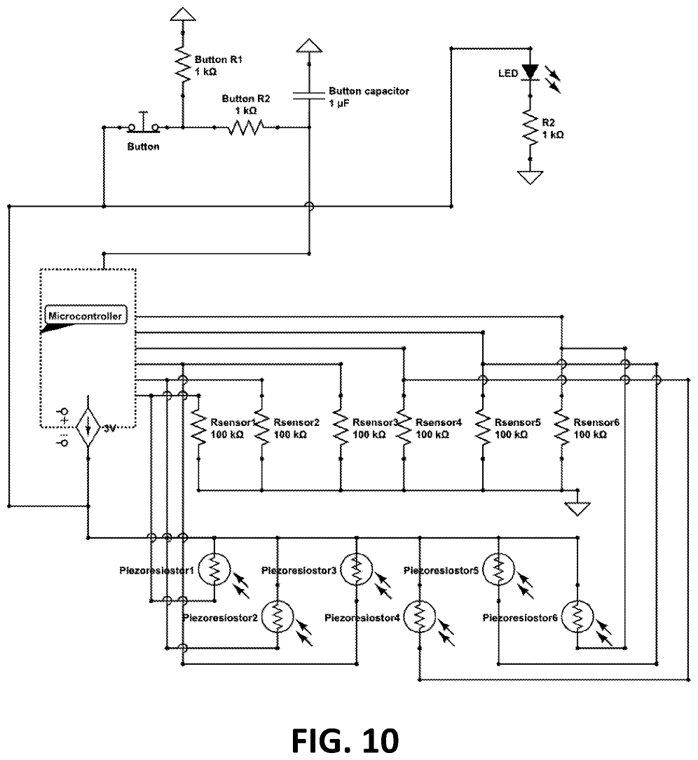

The circuitry combines and powers all of the embedded sensors. The required resistors, capacitors, the button with integrated LED, breakout blocks and the Intel Edison microcontroller are all housed in the back section of the left platform. Alternatively, the components could be housed in other portions of the system as is known to or conceivable to one of skill in the art. All wires, including the USB cable (transferring both power and information to the device) converge in this 5 cm×8 cm×5 cm compartment. The circuit schematics are shown in FIG. 10. FIGS. 9A-9C show the CAD models of the molds used to create the embedded sensors. FIG. 9A is the mold for the heel sensor, FIG. 9B is for the two front sensors and FIG. 9C is the attachment module also embedded into the silicone which allowed for stable attachment.

The microprocessor is attached to three additional components: microcontroller, a FTDI basic breakout, and a protoboard with custom circuitry. Each sensor is connected to the power source and read by the processor through a voltage divider circuit (with 100 k Ohm resistance to ground). The button is attached to a filter circuit to eliminate reverberation when pressed, which might cause multiple button presses.

Assembly:

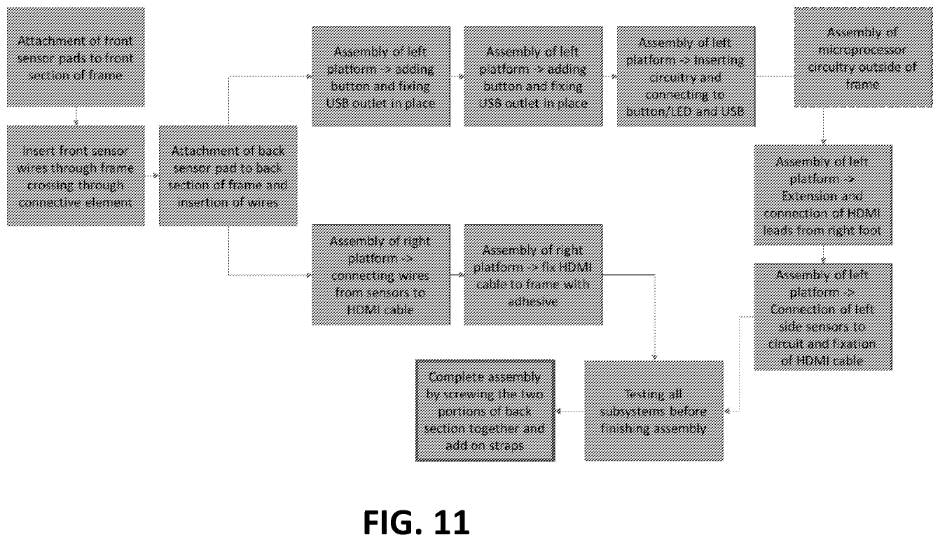

During assembly of physical components, it is very important to test every component after every stage, specifically to assure continued connection of all wiring. A very sensitive aspect of the assembly process is connection through the coiled HDMI wire. The leads under the shielding are extremely thin. Terminal blocks were utilized to stabilize the wires and to create a more durable connection. The HDMI wire was inserted through holes drilled in the sides of the frames and these holes were later filled with black silicone adhesive, which hold the wires. The assembly process follows the diagram in FIG. 11. FIG. 10 shows the circuit schematics for sensory communication and button/LED functionality.

Software Documentation:

The purpose of the software and the following documentation is to provide users with modular libraries that carry out separated functionality for interfacing with the hardware and electronics. The software iterations were separated into two distinct stages. The first iteration was just a working prototype that was hard to modify and not very modular. This was all programmed in the microcontroller.

The actuation of the present invention can be carried out using a computer, non-transitory computer readable medium, or alternately a computing device or non-transitory computer readable medium incorporated into the robotic device or the imaging device.

A non-transitory computer readable medium is understood to mean any article of manufacture that can be read by a computer. Such non-transitory computer readable media includes, but is not limited to, magnetic media, such as a floppy disk, flexible disk, hard disk, reel-to-reel tape, cartridge tape, cassette tape or cards, optical media such as CD-ROM, writable compact disc, magneto-optical media in disc, tape or card form, and paper media, such as punched cards and paper tape. The computing device can be a special computer designed specifically for this purpose. The computing device can be unique to the present invention and designed specifically to carry out the method of the present invention. The operating console for the device is a non-generic computer specifically designed by the manufacturer. It is not a standard business or personal computer that can be purchased at a local store. Additionally, the console computer can carry out communications with the scanner through the execution of proprietary custom built software that is designed and written by the manufacturer for the computer hardware to specifically operate the hardware.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A system for computer control comprising:
a housing shaped to accommodate a foot of a user;
a pad disposed on a surface of the housing;
a force sensor embedded in the pad, wherein the force sensor is configured to be actuated by the foot of the user; and
a non-transitory computer readable medium programmed for translating output from the force sensor into control commands for a computing device.

2. The system of claim 1 further comprising a housing for a left foot of the user and a housing for a right foot of the user, such that the user can control the computer with both feet.

3. The system of claim 2 wherein the housing for the left foot of the user and the housing for the right foot of the user are individually controllable.

4. The system of claim 1 further comprising the pad comprising a front portion and a back portion.

5. The system of claim 1 wherein the housing comprises a front portion and a back portion.

6. The system of claim 5 wherein the front portion and the back portion are coupled by rails, wherein the rails allow for adjustability of the size of the housing.

7. The system of claim 1 wherein the pad is formed from silicone.

8. The system of claim 1 further comprising a microcontroller.

9. The system of claim 1 further comprising a microprocessor.

10. The system of claim 1 further comprising a graphical user interface (GUI).

11. The system of claim 1 further comprising three sensors.

12. The system of claim 11 further comprising one of the three sensors being embedded in a front portion of the pad and two of the three sensors being embedded in a back portion of the pad.

13. The system of claim 1 further comprising the force sensor being embedded adjacent to a ground contact point.

14. The system of claim 1 wherein the non-transitory computer readable medium is programmed for the input from the force sensor to be translated to approximate keyboard strokes.

15. The system of claim 1 wherein the force sensor is configured for gradual change in resistance value when force is applied to the force sensor.

16. The system of claim 1 further comprising configuring the sensor for commands.

17. The system of claim 1 further comprising multiple force sensors, wherein the multiple force sensors are engaged in different configurations to generate different commands.

18. The system of claim 1 further comprising the GUI being configured for user input of settings for the force sensors.

19. The system of claim 17 further comprising the GUI being configured for the user to input commands associated with different combinations of engaging the multiple force sensors.

20. The system of claim 17 further comprising the multiple force sensors being configured to generate different commands based on the pressure applied to the multiple force sensors.
